(19) United States
(12) Patent Application Publication
(10) Pub. No.: US 2020/0351454 A1
(43) Pub. Date: Nov. 5, 2020

(54) WISH: WAVEFRONT IMAGING SENSOR WITH HIGH RESOLUTION

(71) Applicant: William Marsh Rice University, Houston, TX (US)

(72) Inventors: Yicheng Wu, Houston, TX (US); Manoj Kumar Sharma, Houston, TX (US); Ashok Veeraraghavan, Houston, TX (US)

(73) Assignee: William Marsh Rice University, Houston, TX (US)

(21) Appl. No.: 16/863,621

(22) Filed: Apr. 30, 2020

Related U.S. Application Data
(60) Provisional application No. 62/840,965, filed on Apr. 30, 2019.

(51) Int. Cl. H04N 5/33

(52) U.S. Cl. CPC H04N 5/332

(57) ABSTRACT

A system for a wavefront imaging sensor with high resolution (WISH) comprises a spatial light modulator (SLM), a plurality of image sensors and a processor. The system further includes the SLM and a computational post-processing algorithm for recovering an incident wavefront with a high spatial resolution and a fine phase estimation. In addition, the image sensors work both in a visible electromagnetic (EM) spectrum and outside the visible EM spectrum.

### CROSS-REFERENCE TO RELATED APPLICATIONS

This Application claims the benefit of U.S. Provisional Application 62/840,965 filed on Apr. 30, 2019.

### STATEMENT REGARDING FEDERALLY SPONSORED RESEARCH OR DEVELOPMENT

This invention was made with Government Support under Grant Numbers IIS-1652633 and IIS-1730574 awarded by the National Science Foundation and Grant Numbers HR0011-16-C-0028 and HR0011-17-C-0026 awarded by the Defense Advanced Research Projects Agency. The government has certain rights in this invention.

### REFERENCE TO A COMPACT DISK APPENDIX

Not applicable.

### BACKGROUND OF INVENTION

Light behaves as a wave, which can be characterized by its amplitude and phase. However, the current imaging sensors such as complementary metal oxide semiconductor (CMOS) sensors completely lose the phase information and limit the design of conventional imaging systems to mapping all information to only the amplitude of the incoming field. This mapping is not always feasible and results in many limitations. In contrast, the goal of wavefront sensing is to simultaneously measure the amplitude and phase of an incoming optical field. The combination of these two pieces of information enables the retrieval of the optical field at any plane, which provides a larger latitude and more flexibility in the design of imaging systems.

### SUMMARY OF INVENTION

In one aspect, embodiments disclosed herein generally relate to a system for a wavefront imaging sensor with high resolution (WISH) comprises a spatial light modulator (SLM), a plurality of image sensors and a processor. The system further includes the SLM and a computational post-processing algorithm for recovering an incident wavefront with a high spatial resolution and a fine phase estimation. In addition, the image sensors work both in a visible electromagnetic (EM) spectrum and outside the visible EM spectrum.

In another aspect, embodiments disclosed herein relate to a method for a WISH imaging including illuminating a target with a coherent light source, modulating an incident wavefront from the target by projecting multiple random phase patterns on a SLM, and capturing corresponding a plurality of intensity images using a plurality of image sensors. The method further includes acquiring sequential pairs of the phase patterns on the SLM and captured plurality of intensity images, processing an acquired data using a computational post-processing algorithm, and recovering a high-resolution wavefront based on the computational post-processing algorithm.

In another aspect, embodiments disclosed herein relate to a non-transitory computer readable medium storing instructions. The instructions are executable by a processor and comprise functionality for illuminating a target with a coherent light source, modulating an incident wavefront from the target by projecting multiple random phase patterns on a SLM, and capturing corresponding a plurality of intensity images using a CMOS sensor. The instructions further include acquiring sequential pairs of the phase patterns on the SLM and captured plurality of intensity images, processing an acquired data using a computational phase-retrieval algorithm, and recovering a high-resolution wavefront based on the computational post-processing algorithm.

Other aspects and advantages of one or more embodiments disclosed herein will be apparent from the following description and the appended claims.

### BRIEF DESCRIPTION OF DRAWINGS

FIG. 1 is a schematic overview of a system for a wavefront imaging sensor with high resolution (WISH) in accordance with one or more embodiments;

FIG. 2 shows a recovering high-resolution wavefront using the WISH in accordance with one or more embodiments;

FIG. 3 shows a micron-resolution imaging from meters away by combining the WISH and a Fresnel lens in accordance with one or more embodiments;

FIG. 4 is a schematic overview of looking through a diffuser without losing resolution by the WISH in accordance with one or more embodiments;

FIG. 5 shows a WISH for lensless microscopic imaging in accordance with one or more embodiments;

FIG. 6 shows a reconstruction performance for different numbers of measurements in accordance with one or more embodiments;

FIG. 7 shows a measurement matrix under different conditions in accordance with one or more embodiments;

FIG. 8 shows simulation results to show how the SLM pixel size and sensor pixel size affect the reconstruction error in accordance with one or more embodiments;

FIG. 9 shows experimental results to image a USAF resolution target with a Fresnel lens in accordance with one or more embodiments;

FIG. 10 shows a depth estimation for planar objects at different depths based on the recovered amplitude in accordance with one or more embodiments;

FIG. 11 shows a depth estimation for a depth-varying object based on the recovered phase in accordance with one or more embodiments;

FIGS. 12a and 12b show a computing system in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding.

However, it will be apparent to one of ordinary skill in the art that embodiments may be practiced without these specific details. In other instances, well-known features have not been described in detail to avoid unnecessarily complicating the description.

In the following description, any component described with regard to a figure, in various embodiments of the present disclosure, may be equivalent to one or more like-named components described with regard to any other figure.

For brevity, at least a portion of these components are implicitly identified based on various legends. Further, descriptions of these components will not be repeated with regard to each figure. Thus, each and every embodiment of the components of each figure is incorporated by reference and assumed optionally present within every other figure having one or more like-named components. Additionally, in accordance with various embodiments of the present disclosure, any description of the components of a figure is to be interpreted as an optional embodiment, which may be implemented in addition to, in conjunction with, or in place of the embodiments described with regard to a corresponding like-named component in any other figure. In the figures, black solid collinear dots indicate that additional components similar to the components before and/or after the solid collinear dots may optionally exist.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements, if an ordering exists.

The term data structure is understood to refer to a format for storing and organizing data.

Introduction

Traditional wavefront sensors fall into two groups. The first group is based on geometrical optics. Shack-Hartmann wavefront sensor (SHWFS) is the most frequently used geometric design, which builds an array of lenses in front of a CMOS sensor. Each lens provides measurements of the average phase slope (over the lensed area) based on the location of the focal spot on the sensor. To achieve high phase accuracy, many pixels are required per lens to precisely localize the spot. Thus, although the CMOS sensor has millions of pixels, the spatial resolution of the measured complex field is very low. Currently, commercial SHWFSs offer up to 73×45 measurement points, which is useful to estimate only smooth phase profiles such as air turbulence. The second group is designed based on diffractive optics. The phase information is encoded into interferometric fringes by introducing a reference beam. However, these interferometric systems have the following two limitations: (a) the systems are bulky and heavy due to the increased optical complexity, and (b) the systems are highly sensitive to micrometer-scale vibrations.

Our key insight is to capitalize upon the field of computational imaging, which provides an elegant framework to codesign advanced computational algorithms and optics to develop new solutions to traditional imaging techniques and design a non-interferometric, high-resolution (multimegapixel) system. Many other limits that were considered fundamental have been overcome by this joint design approach of the present disclosure. For example, superresolution microscopes such as PALM and STORM achieve subdiffraction-limit imaging by combining photoswitchable fluorophores with high-accuracy localization algorithms. Fourier Ptychography offers a high space-bandwidth product using an LED array microscope with phase retrieval algorithms. Non-line-of-sight imaging enables one to look around the corner by utilizing the time-of-flight setups and 3D reconstruction algorithms.

The traditional wavefront sensors are recognized to suffer from low spatial resolution and/or high vibration-sensitivity to directly measure the phase. The present disclosure may avoid these drawbacks by combining optical modulation and computational optimization. Specifically, two cutting-edge technologies are used. First, the current high-performance CMOS technology enables the production of high-resolution, high-frame-rate image sensors and spatial light modulators (SLMs). Second, recent advances in the phase retrieval algorithms and computational power enable to efficiently solve large-scale optimization problems. By combining these two technological advances, high-resolution intensity measurements may be recorded and indirectly recover the phase using the phase retrieval algorithms.

One or more embodiments are inspired by recent efforts of various research groups to measure the wavefront computationally using sequential captures with an SLM. However, the current techniques suffer from two limitations that are aimed to directly address. First, the spatial resolution of the acquired wavefronts is limited. Second, these systems are not optimized for acquisition speed, which makes the sensor incapable of imaging dynamic scenes. On the other hand, while existing single-shot wavefront sensors achieve high frame rate recording, they typically rely on assumptions such as the sparsity and severely limit the applicability of these systems to generic applications.

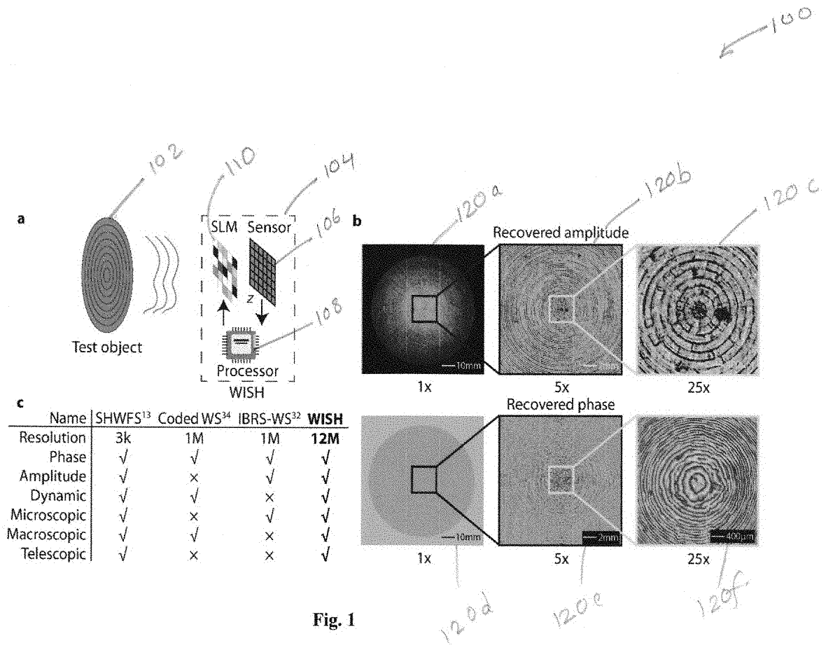

One or more embodiments of the present disclosure may provide a wavefront imaging sensor with high resolution (WISH), which offers multimegapixel resolution, high frame rate, and robustness to vibrations as shown in a system 100 of FIG. 1. The WISH 140 consists of a SLM 110, a CMOS sensor 104 and a processor 108. The CMOS sensor 104 is an image sensor which works in a visible electromagnetic (EM) spectrum. Examples representative of these image sensors in one or more embodiments include both in the visible EM spectrum and outside the visible EM spectrum. The WISH imaging works by first modulating the optical field with multiple random SLM patterns and capturing the corresponding intensity-only measurements using the CMOS sensor 104. Then, the acquired data are processed using a computational post-processing algorithm, for example, a computational phase-retrieval algorithm, which estimates the complex optical field incident on the SLM 110. The computational post-processing algorithm is either based on optimization of an energy function or based on a neural network trained on data. For one or more embodiments, the energy function describes the difference between the estimated intensity and the captured intensity on the sensor plane. A gradient-descent or iterative algorithm is applied to find the incident optical field. For some embodiments, a network learns a function between the input intensity images and the output optical field from training data. New optical field can be predicted by feeding intensity images into the trained network. The spatial resolution of the recovered field is larger than 10 megapixels. In comparison with the traditional SHFWS, this is more than 1000× improvement in spatial resolution. Compared with other recent designs of wavefront sensors, the WISH achieves more than 10× improvement in spatial resolution. Although multiple shots are necessary to recover one complex field, the WISH can record dynamic scenes with a frame rate of up to 10 Hz. Last but not the least, because the design is reference-free, the WISH is robust to environmental noise and motion, which broadens the variety of application domains where this technology can be integrated. In addition, the WISH covers different ranges of the EM spectrum such as visible, infrared, thermal, ultra-violet, X-ray, or like ranges.

Results

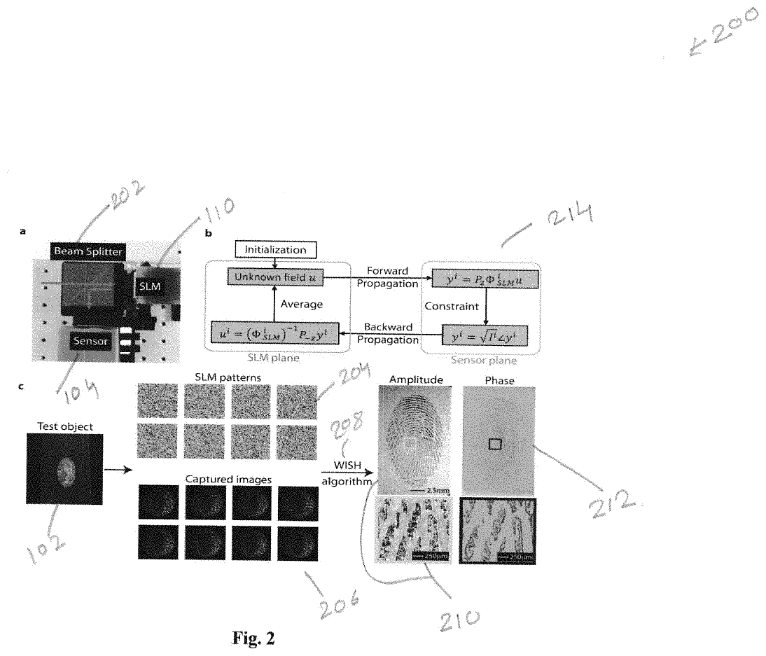

To validate the proposed wavefront sensing technique, a table-top prototype is constructed as shown in a system 200 of FIG. 2a. The system 200 is illuminated with green light generated using a 532-nm-wavelength module diode laser (Z-LASER Z40M18B-F-532-PZ). The phase distribution of the incident light is modulated using a phase-only SLM (HOLOEYE LETO, 1920×1080 resolution, 6.4 μm pitch size). Because the SLM 110 operates in the reflective mode, a 25.4-mm beam splitter 202 is inserted to guide the field into the sensor 104. The distance between the SLM 110 and the sensor 104 is ˜25 mm. The sensor 104 is a 10-bit German Basler Ace camera (acA4024-29um) equipped with a Sony IMX-226 CMOS sensor (1.85 μm pixel pitch, 4024×3036 resolution).

During the acquisition, multiple phase modulation patterns were projected onto the SLM 110. The SLM patterns modulated the incoming optical field before propagating towards the sensor 104, which recorded 2D images that corresponded to the intensity of the field at the sensor plane. The phase information of the modulated field was not recorded. Multiple uncorrelated measurements were recorded with different SLM patterns to enable the algorithm to retrieve the phase. In an ideal setting, the SLM pattern should be fully random to diffract the light to all pixels of the sensor to improve the convergence and accuracy of the iterative retrieval algorithm. However, the cross-talk effect from the SLM 110 becomes a serious issue, especially for high-frequency patterns, which deteriorates the quality of the recovered image. Moreover, due to the finite size of the sensor 104, the SLM 110 should only diffract light to the level that the sensor can capture most of the signal. In one or more embodiments for experiment, the SLM patterns are first generated by low-resolution random matrices and subsequently interpolated to match the SLM resolution (see the Methods section for more details on SLM pattern designing).

Mathematically, for each measurement IL captured with the corresponding random phase modulation Φ_{SLM}ⁱ, the forward model is as follows:

\sqrt{Iⁱ}=|P_{z}(Φ_{SLM}ⁱ·u)| (1) (1)

where u is the unknown field that falls on the SLM. The symbol “·” denotes Hadamard product to represent the elementwise multiplication between the phase on the SLM and the field. P_{z} is the propagation operator (at the propagating distance z), which is modeled as Fresnel propagation (see Methods).

To estimate field u from K measurements, the following optimization problem is formed:

$$\hat{u} = arg {min}_{u} {\sum }_{i = 1}^{K} ‖ \sqrt{{I}^{i}} - \vert {P}_{z} ( {Φ}_{SLM}^{i} ∘ u ) \vert ‖ \qquad ( 2 ( 2 )$$

This is a phase retrieval problem, which is nonlinear and nonconvex. There are many quality algorithms to solve such problem. Here, Gerchberg-Saxton (GS) algorithm is applied to recover the field u by alternating projections between the SLM and the sensor plane, as illustrated in a system 214 of FIG. 2b. The detailed derivation and implementation of the algorithm can be found below.

To correctly recover the unknown field, a minimum number of measurements K is required for the algorithm to converge. Intuitively, a more complicated field u requires more measurements as an input. When the prior information of the unknown object is available, such as the sparsity or support, potentially far fewer measurements are required. In one or more embodiments, no constraint is applied to the unknown field to make our sensor valid for objects with an arbitrary phase distribution. More discussion and the number of measurements for each experiment is listed in the Method Section.

The resolution of the WISH is determined by the pixel size of the SLM δ_{SLM}, pixel size of the camera sensor δₛₑₙₛₒᵣ, and distance z between them. As shown below, in most cases when δ_{SLM} is larger than δₛₑₙₛₒᵣ, the resolution is limited by δₛₑₙₛₒᵣ, as long as z is sufficiently large to enable each sensor pixel to receive the field from multiple SLM pixels. As a result, although smooth SLM patterns (i.e., large effective SLM pixel size) are used in our experiment, WISH offers the full sensor resolution.

To experimentally demonstrate how the WISH works, a fingerprint is imaged on a glass microscope slide with dusting powder, which is placed ˜76 mm from the sensor. As shown in FIG. 2c, eight random patterns 204 were sequentially projected on the SLM 110, and the corresponding images 206 were captured by the CMOS sensor 104. Based on the introduced the WISH algorithm, both amplitude 210 and phase 212 were retrieved with high resolution. The phase distribution of the ridge patterns significantly varies because the fingerprint powder randomly scatters light.

Since the WISH offers the unique capability to simultaneously measure the amplitude and phase in high resolution, it may become a powerful tool to solve the inverse imaging problems with deterministic or even random transfer functions. In some embodiments, the WISH may be applied to the full gamut of spatial scales. In one or more embodiments, in the telescopic scale, for the first time, the diffraction-limited high-resolution imaging is demonstrated using a large-aperture but low-quality Fresnel lens. In one or more embodiments, in the macroscopic scale, the utility of the WISH is shown for obtaining high-resolution images of objects obscured by scattering. In one or more embodiments, in the microscopic scale, the WISH may be converted into a lensless microscope for biological imaging with high spatial and temporal resolution.

### EXAMPLE APPLICATION I

### Long-Distance, Diffraction-Limited Imaging with a Fresnel Lens

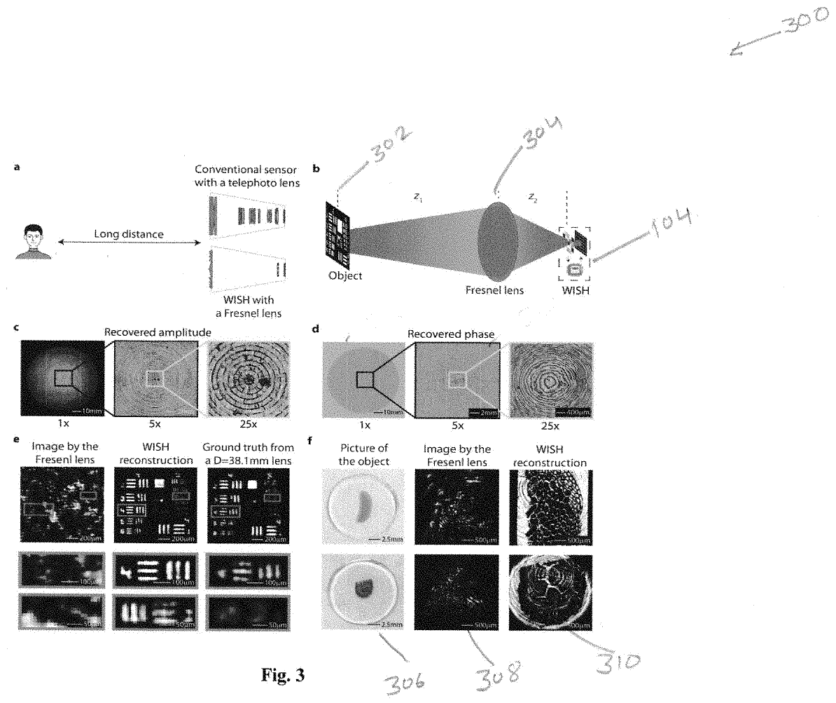

In some embodiments, many optical imaging or computer vision applications such as astronomical observation, satellite imaging, and surveillance, the imaging device is located very far from the object. However, to capture a photograph of a person 1 km away using a conventional sensor, for example, requires a telephoto lens, which contains dozens of single lenses to accommodate for diffraction blur and aberrations, as shown in a system 300 of FIG. 3a. Instead, in one or more embodiments of the present disclosure the WISH 140 is combined with a light and inexpensive Fresnel lens 304 to achieve the same performance. The Fresnel lens 304 plays the following two important roles here: (a) increasing the effective aperture size and (b) focusing light onto a small region to improve the signal-to-noise ratio. However, by itself, a Fresnel lens cannot produce a high-quality image on the sensor due to aberrations and distortions. The WISH 140 enables to computationally compensate for these aberrations and distortions, thereby achieving compact, large-aperture, diffraction-limited imaging.

To demonstrate this capability, images of objects at 1.5 meters away using a 76.2-mm diameter Fresnel lens are captured as shown in FIG. 3b. The complex object x is illuminated with a known phase distribution L (e.g., constant phase for a collimated light source or quadratic phase for a point source). The wavefront propagates distance z₁ before hitting the Fresnel lens 304. Fresnel lens F gathers the field inside the entire aperture to the wavefront sensor at distance z₂. The forward model is described by the following:

u₃=P_{z}_{₂}(F·P_{z}_{₁}(L·x)) (3) (3)

After the complex field u₃ has been retrieved by the WISH, object x can be obtained by backward propagation as follows:

x=L⁻¹·P_{-z}_{₁}(F⁻¹·(P_{-z}_{₂}u₃)) (4)(4)(5)

However, F contains unknown aberrations and must be calibrated beforehand. During the calibration, the object is removed so that the incident light directly shines on the Fresnel lens. In this case that x=1, the corresponding field u₃₀ is recovered by the WISH on the SLM plane. Then, based on Eq. 3, the lens field is calculated as follows:

F=(P_{z}_{₁}L)⁻¹·P_{-z}_{₂}u₃₀ (6) (5)

The calibration process is required only once for a given lens and does not need to be repeated as the object or setup changes. FIGS. 3c and 3d show the calibrated amplitude and phase of the Fresnel lens (Edmund Optics #43-013) with a 254-mm focal length. Zoomed-in images at 5× and 25× demonstrate details of the recovered field. The amplitude shows that the lens has an effective diameter of ˜76.2 mm, which mainly consists of concentric circles with imperfections due to manufacturing defects. The phase is roughly quadratic with large aberrations.

For the quantitative evaluation, a standard 1951 USAF resolution test chart is used as the object shown FIG. 3e. First, images are directly captured using a Fresnel lens with zero phase on the SLM, as shown in the left column. Due to the huge aberrations from the Fresnel lens, none of the features are recognizable in the image. After reconstruction, the result in the middle column shows that the features can be well resolved up to group 5, element 3 (12.40 μm line width). Because it is very difficult to find an aberration-free lens with the same aperture size as the Fresnel lens for direct comparison, the ground truth images are captured using a high-quality lens (Thorlabs AC508-250-A-ML and a 38.1-mm diameter aperture), whose diameter is half of that of the Fresnel lens. The best resolvable feature captured by the high-quality lens is group 4, element 4 (22.10 μm line width). Since the diffraction blur size is inversely proportional to the aperture size, it may be inferred that the smallest visible line for a diffraction-limited 76.2-mm-diameter lens is 11.05 μm wide, which is similar to the resolution in our reconstruction. Thus, the WISH may nearly achieve the diffraction-limited resolution using a large and highly aberrated Fresnel lens.

Additionally, two prepared biological microscope slides from AmScope are tested to demonstrate that microfeatures can be recovered at 1.5 m. Compared to the USAF target, these samples are more challenging because they are not binary, which reduces the contrast between the foreground and the background. In FIG. 3f, the first column is a cross section of rabbit testis and shows 200-μm-diameter cells recognizable with fine details such as the nuclei and membrane. The second column is a cross-section of dog esophagus. In comparison to the entirely distorted image, which was directly captured from the Fresnel lens, reconstructed image of one or more embodiments shows clear blood vessels that are 20-150 μm in diameter. There are ring artifacts on the background due to a small misalignment in the experiment.

### EXAMPLE APPLICATION II

### Imaging Through Scattering Media

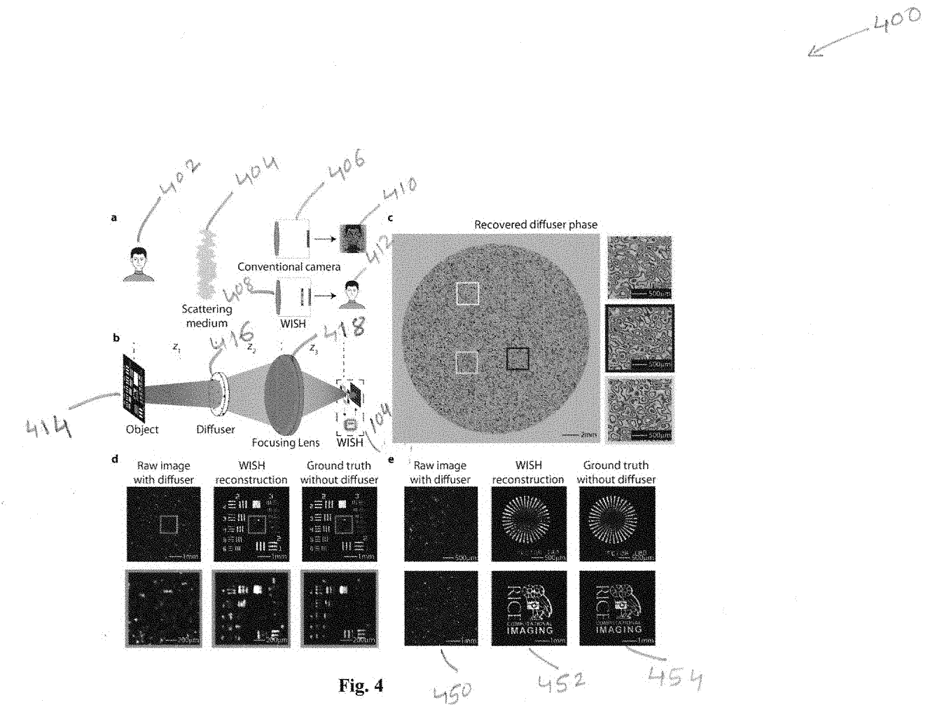

Seeing through fog or beneath the skin is an extremely challenging task due to scattering. As shown in a system 400 of FIG. 4a, if a person 402 is hidden behind scattering media 404, most of the key features are lost when captured by a conventional camera 406. It has been shown that the transfer function of volumetric scattering media can be modeled as a complex linear system (called the scattering matrix or transmission matrix), and this system can be inverted (the effects of scattering are undone) if complete field measurements can be obtained at the sensor. By measuring the phase distortion and computationally inverting it, the WISH can reconstruct the objects hidden by a thin scatterer. As illustrated in FIG. 4b, the wavefront from an object 414 is scattered by a highly random diffuser D 416 at distance z₁. A focusing lens 418, which is modeled as quadratic phase distribution Φₗₑₙₛ, collects diffused light to the WISH 104. However, this lens is not mandatory if the diffuser is near the sensor.

First, the diffuser is calibrated by illuminating it with collimated light from the far side. The WISH measures the scattered field on the SLM plane v₄₀, and the diffuser can be calculated as follows:

D=P_{-z}_{₂}(Φₗₑₙₛ·P_{-z}_{₃}v₄₀) (7) (6)

After the calibration, a hidden object is placed behind the diffuser. Based on the recovered field v₄ from the WISH, the field of the object can be recovered by numerical backward propagation as follows:

x=P_{-z}_{₁}(D⁻¹·P_{-z}_{₂}(Φₗₑₙₛ·P_{-z}_{₃}v₄)) (8)(7)

To test the system, various objects are imaged through a 25.4-mm diameter diffuser (Edmund Optics 47-988). The objects were placed 80 cm behind the diffuser and illuminated by a collimated laser beam. After light from the object passes through the diffuser, the wavefront is converged by a 50.8-mm-diameter lens with 180-mm focal length (Thorlabs AC508-180-A) and captured by the WISH (z₃=18 cm).

The calibrated phase profile of the diffuser is plotted in FIG. 4c. The left side shows the entire diffuser, which is 23.8 mm in diameter, while the right side provides three magnified regions. This phase map corresponds to the physical height of the structures on the diffuser, which randomly diffracts light and causes large phase aberrations. For the direction with the largest gradient, a 2π phase shift is ˜7 pixels (31.5 μm). The amplitude part of the diffuser is almost flat and unimportant since the diffuser does not absorb much light.

Images of the USAF resolution chart are captured to evaluate the performance of the reconstruction as shown in FIG. 4d. The left column 450 shows direct-captured images with the diffuser. Due to the random phase from the diffuser, this image contains only speckle patterns with no visible information under coherent illumination. In the middle column 452, the distortion from the diffuser is computationally removed, and the object is recovered using one or more embodiments of the present disclosure. For comparison, the images captured without the diffuser are displayed in the right column 454. The center regions, which are highlighted in red, are magnified and presented in the bottom row. For the reconstruction, the best resolvable feature is group 4, element 2 with a bar width of 27.84 μm. The ground truth (without the diffuser) shows that the smallest feature size is 24.80 μm (group 4, element 3). Although the diffuser completely destroys the field, our algorithm removes nearly all distortions and recovers the object. Since there is no object constraint in the algorithm of one or more embodiments of the present disclosure, various objects can be similarly reconstructed. FIG. 4c shows the the raw captured images look random due to the diffuser, the reconstruction is comparable to the ground truth captured without the diffuser.

Similar to Katz et al., it is straight-forward to expand method of one or more embodiments of the present disclosure from the transmissive mode to the reflective mode, which may be useful for applications such as looking around the corner with a diffused wall.

### EXAMPLE APPLICATION III

### Lensless Microscopy

By bringing samples near the sensor, the WISH can be converted into a lensless microscopy system. Lensless imaging techniques can result in extremely lightweight and compact microscopes. Pioneering work has demonstrated the applications in holography, fluorescence and 3D imaging. Although a lens-based microscope has a tradeoff between the field of view (FOV) and resolution, lensless microscopy offers high-resolution while maintaining a large FOV.

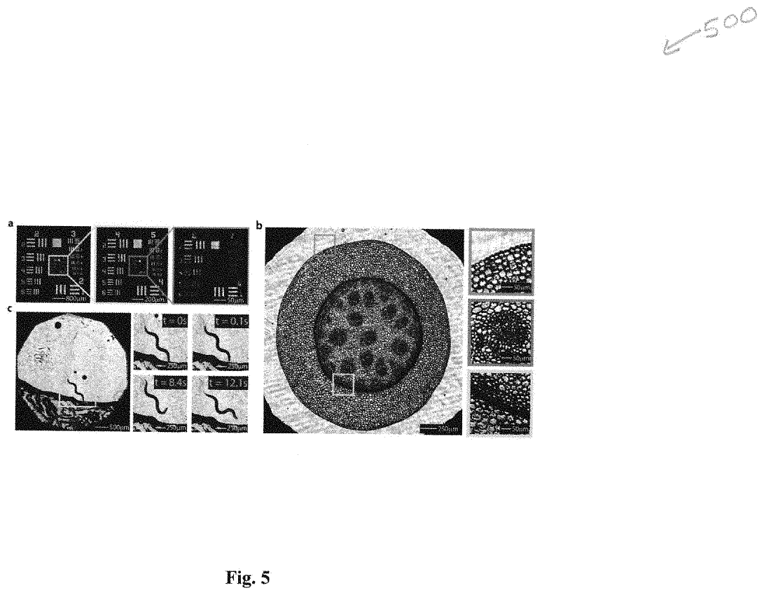

In one or more embodiments, the WISH is tested as a lensless microscope by measuring a standard resolution target and biological samples. As shown in FIG. 5a, a large region of a USAF target is imaged with the smallest visible features in group 6, element 5 (4.92 μm bar width). Currently, due to the necessity of a beam splitter, the resolution is limited by the space between the sample and the SLM. Replacing the reflective SLM by a transmissive SLM is a potential solution to increase the spatial resolution. FIG. 5b shows the reconstruction of cells from lily-of-the-valley (Convallaria majalis). Three subregions are magnified to show the characteristic features in the sample.

The ability to observe a dynamic scene is also crucial to understand the behavior of the live samples. By optimizing the syncing between the SLM and the sensor, acquisition speeds of up to 20 Hz is achieved (see Methods). During the reconstruction, eight frames are input to the algorithm with a sliding window of two frames, which results in a recovered video with a 10-Hz frame-rate. Assuming that the change between neighboring frames is small, the converged reconstruction from the previous frame may be used as the initialization of the next frame, which significantly speeds up the reconstruction. As an illustration, a video of a Caenorhabditis elegans living on agar is captured. Several frames from the reconstructed video are shown in FIG. 5c. Although the current prototype may only achieve approximately 10 Hz high-resolution full-wavefront imaging, this is not a fundamental constraint of the proposed design but a limitation imposed by the choice of SLM. By using faster SLMs, 100-1000 Hz, high-resolution, full-wavefront sensing capabilities may be achieved using the WISH design.

Discussion

In one or more embodiments, the computational-imaging-based method WISH is a high-resolution, non-interferometric wavefront sensor, which shifts the complexity from hardware to algorithm and offers the ability to measure highly variant optical fields at more than 10-megapixel resolution. Experimentally, it is shown that the WISH may recover both objects at high resolution and perform diffraction-limited reconstruction in highly distorted optical systems. The versatility of the sensor of one or more embodiments of the present disclosure may significantly improve the performance of existing technologies such as adaptive optics and microscopy while providing a new tool for emerging fields including imaging through scattering media and biomedical and scientific imaging. Designing an optimization framework to automatically separate the object and aberrations without calibration is of great interest to applications such as autonomous driving (in challenging weather) and imaging beneath the skin.

Materials and Methods

SLM patterns design. The SLM pattern should satisfy three requirements. First, to improve convergence and reduce noise, the field from multiple SLM pixels should be able to randomly interfere. Second, to increase the signal-to-noise ratio, the field should not be scattered too much to ensure that the sensor collects most of the scattered light. Third, to reduce the impact of the cross-talk effect, the pattern should be locally smooth. For each SLM pattern in the experiment of one or more embodiments of the present disclosure, first a 192×108 random matrix with a uniform distribution of 0-1 is generated. Then, the matrix is unsampled by a factor of 10 using bicubic interpolation in MATLAB to create grayscale images of resolution 1920×1080. These grayscale images were used as the SLM patterns.

Numerical Propagation Model. The numerical propagation is modeled as a Fresnel propagation (FP) as follows:

$$U ( {r}_{2} ) = {P}_{z} \{ U ( {r}_{1} ) \} = Q [ \frac{1}{z} , {r}_{2} ] V [ \frac{1}{λ z} , {r}_{2} ] ℱ [ {r}_{1} , {f}_{1} ] Q [ \frac{1}{z} , {r}_{1} ] \{ U ( {r}_{1} ) \} \qquad ( 8 )$$

The output field U(r₂) is computed (from right to left) by multiplying the input field by a quadratic phase (Q), Fourier transforming ( [symbol] ), scaling by a constant phase (V) and multiplying by another quadratic phase factor (Q). Although the angular-spectrum propagation (ASP) is more accurate in theory, both FP and ASP gave nearly the same result in current setup of one or more embodiments. Additionally, FP has two advantages: (1) there is only one Fourier transformation (FT) instead of two in ASP, which reduces the computation in the iterative algorithm, and (2) the grid spacing in the input and output planes must be identical for ASP, while FP may have different spacings in the input and output planes. Thus, FP may save unnecessary sampling for the case when the input and output fields have notably different sizes (e.g., recovering the wavefront of a large-aperture Fresnel lens from the WISH).

Image acquisition and reconstruction. In the experiment, 32 patterns were used for the setup with the Fresnel lens (FIGS. 1 and 3) and diffuser (FIG. 4) and 8 patterns for the other experiments (FIGS. 2 and 5). For each SLM pattern, two 10-bit images were acquired and averaged them to reduce the effect of noise. No high-dynamic range (HDR) measurement was required.

During the reconstruction, the data was split into batches, where each batch contained four SLM patterns and their corresponding measurements. All batches were individually processed in an NVIDIA Tesla K80 GPU with 12 GB RAM and averaged in each iteration.

Video recording for dynamic scenes. The LETO SLM provides a synchronization signal at 60 Hz, which is used to trigger the CMOS sensor. Due to the delay between sending the phase pattern and refreshing it on the SLM, the SLM patterns were changed at 20 Hz and kept only the last frame for every three frames captured from the sensor to ensure that the captured image was stable.

WISH Algorithm

Without loss of generality, let's consider the 1D case and ignore boundary effects. The forward model is

\sqrt{Iⁱ}=|P_{z}Φ_{SLM}ⁱu|=|Aⁱu| (9) (9)

For multiple SLM patterns, the measurement matrix can be stacked together.

$$\sqrt{I} = ( \begin{matrix}\sqrt{{I}^{1}} \\ ⋮ \\ \sqrt{{I}^{K}}\end{matrix} ) = ( \begin{matrix}\vert {A}^{1} u \vert \\ ⋮ \\ \vert {A}^{K} u \vert\end{matrix} ) = \vert Au \vert \qquad ( 10 ) ( 10 )$$

To estimate the field u, the optimization becomes

$$\hat{u} = arg {min}_{u} ‖ \sqrt{I} - \vert Au \vert ‖ \qquad ( 11 ) ( 11 )$$

Since A is not a square matrix, pseudo-inverse A⁺ is used here

$${A}^{+} = {( {A}^{*} A )}^{- 1} {A}^{*} = \frac{1}{K} {A}^{*} \qquad ( 12 ) ( 12 )$$

A* is the conjugate transpose of A. Based on the definition of Aⁱ, the conjugate transpose is

Aⁱ*=(Φ_{SLM}ⁱ)⁻¹P_{z}⁻¹=(Φ_{SLM}ⁱ)⁻¹P_{-z} (13)(13)

A good property of the propagation operator is that its inverse is the backward-propagation operator.

Now, if the complex field on the sensor is defined as yⁱ=\sqrt{Iⁱ}exp(jθⁱ), the recovered field û t is written as follows

$$\hat{u} = {A}^{+} y = \frac{1}{K} ( {A}^{1 *} ⋯ {A}^{K *} ) ( \begin{matrix}{y}^{1} \\ ⋮ \\ {y}^{K}\end{matrix} ) = \frac{1}{K} {\sum }_{i = 1}^{K} {( {Φ}_{SLM}^{i} )}^{- 1} {P}_{- z} {y}^{i} \qquad ( 14 ) ( 14 )$$

This formula says that the estimated signal is the average of all different measurements backward-propagated before the SLM pattern.

The iterative algorithm works as explained below (FIG. 2b). The complex field u is first initialized by taking the average fields propagated back from the sensor plane with captured amplitudes and zero phases. In each iteration, the field u modulated by different SLM patterns Φ_{SLM}ⁱ and propagates distance z to the sensor plane. For each complex field yⁱ at the sensor plane, the amplitude is replaced by the corresponding measurement \sqrt{Iⁱ}. Next, these fields are propagated back to the SLM plane. According to the discussion above, uⁱ from different measurements are averaged for the next iteration. The estimation will finally converge to the desired solution.

Required Number of Measurements

To estimate the field u correctly, it is critical to pick the number of measurements K properly. Here, a quantitative evaluation on how K affects the recovered results in 2-D simulations is shown. Specifically, the unknown field is a 64×64 random complex matrix with 1 μm pixel size. Both the SLM and sensor have 512×512 pixels with 1 μm pixel size. The propagation distance between the SLM and the sensor is 500 μm and numerical propagation is calculated by the angular spectrum method. Gaussian noise with 0.01 standard variation is added to all measurements. The error is defined as follows,

$$Error = \frac{{‖ \vert \hat{u} \vert - \vert {u}_{GT} \vert ‖}_{2}}{{‖ {u}_{GT} ‖}_{2}} \qquad ( 15 ) ( 15 )$$

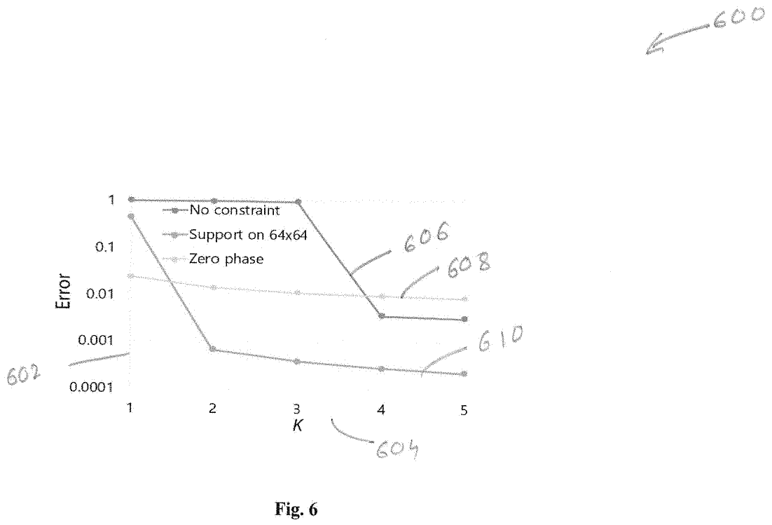

As shown in FIG. 6, when there is no constraint on the unknown field, at least four measurements are required to estimate the field correctly. There is a huge error difference from not converging to converging when K is larger than the threshold. Once K overpasses the minimum requirement, increasing the number of measurements improves the performance slightly by reducing the noise. Next, by adding support confining the field in the 64×64 region, two measurements are sufficient to recover the field. Alternatively, if it is known that the unknown field only contains amplitude information with zero phase beforehand, the correct estimation even with one measurement may be found. It means the number of measurements needed is affected by the prior knowledge significantly.

Wavefront Sensor Resolution Analysis

In order to analysis the sensor resolution, the structure of the forward model (Eq. 9) is considered. When the propagation distance z is short, P_{z} is a band matrix since one pixel of the incident field will fall on a local region of the sensor after its propagation. As z increases, the width of the band increases. When z is large enough that Fraunhofer approximation¹ is satisfied, P_{z} becomes a Fourier transformation. To make setup compact, z is kept to be short (˜30 mm). _{SLM} is a diagonal matrix to have element-wise multiplication with the field u. The combined matrix P_{z}Φ_{SLM}ⁱ is called the measurement matrix Aⁱ, which is essentially a weighted propagation matrix where each column is multiplied by the phase from the SLM. To be able to recover an unknown pixel on u, multiple uncorrelated measurements may be applied to this pixel when different random SLM patterns are projected.

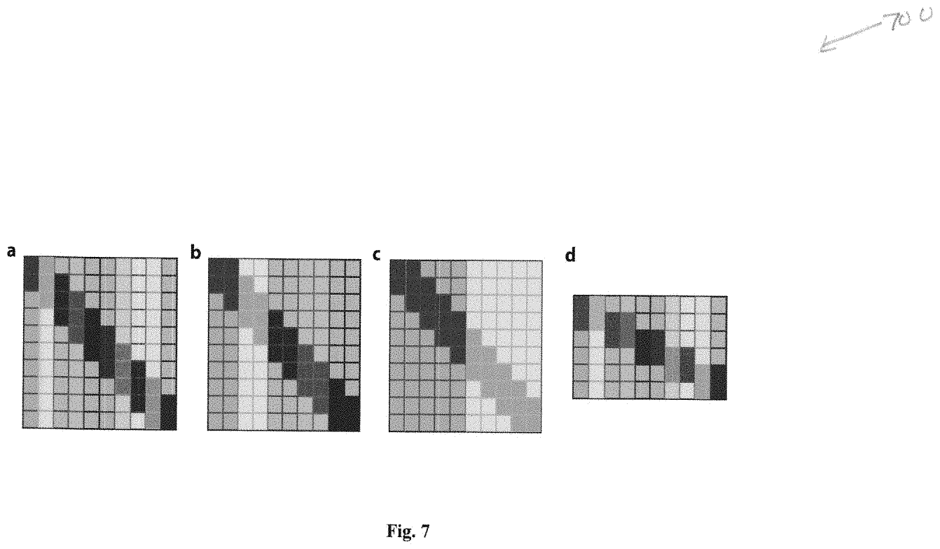

Three different scenarios about the pixel of unknown field δ_{field}, SLM δ_{SLM}, and sensor δₛₑₙₛₒᵣ, are discussed below to determine the resolution limit. The measurement matrixes for different conditions are plotted in FIG. 7. The background band matrix is the propagation matrix, and the colored columns show the weighting by different SLM patterns. Each color corresponds to one SLM pixel, indicating one independent phase shift.

1) δ_{SLM}−δ_{field}=δₛₑₙₛₒᵣ

In this case, each diagonal element of Φ_{SLM} can be changed independently, which means that the weighting on the measurement matrix can also be adjusted freely (FIG. 7a). If Φ_{SLM} is random, with high probability, different rows of the measurement matrix will be orthogonal to each other. Thus, every unknown field pixel can be recovered by the algorithm as long as there are sufficient patterns. For a large propagation distance z when the propagation operator becomes a Fourier transformation, Candes et al. show theoretical guarantees about its convergence.

2) δ_{SLM}=M δ_{field}=M δₛₑₙₛₒᵣ

Since the SLM has a larger pixel size, each SLM pixel modulates M field pixels in the same way. M adjacent elements on the diagonal of Φ_{SLM} are same. And the measurement matrix is weighted by block. When M is small, each row is still modulated by more than one SLM pixel (FIG. 7b). Incoherent measurements are created by changing the phase shift of these pixels. Physically, it means that each sensor pixel will collect the field from multiple SLM pixels. By varying the SLM pixel value, we change how the field from different SLM pixels interference with each other, creating new measurements. But if the SLM pixel size is so large that the field falling on the sensor pixel is just from one SLM pixel (FIG. 7c), only a global phase shift is applied on the field, which will not make any difference on the sensor measurement. Under this condition, no matter how many SLM patterns are projected, incoherent measurements are not sufficient to recover the field back. But if distance z is increased and have a large sensor, then the requirement of the SLM pixel size can be relaxed.

3) δₛₑₙₛₒᵣ=M δ_{field}=M δ_{SLM}

When the sensor pixel size is large, it means that the recorded signal is the sum of all sub-pixel region. As for the measurement matrix, M rows are added together as shown in FIG. 7(d). Since the SLM pixel size is small, each column can be modulated freely. Thus, the recovered field resolution is still the same as the resolution of the SLM, with the cost of increasing the number of SLM patterns by M times for sufficient measurements.

Based on the discussion 1) to 3), the resolution is

δ_{field}=min(δₛₑₙₛₒᵣ, δ_{SLM}) (16) (16)

Next, 2-D simulation to support resolution analysis of some embodiments are discussed. In the simulation, the unknown field is a 64×64 random complex matrix with δ_{field}=1 μm. The entire sensor size is 512 μm×512 μm. Propagation is simulated by the angular spectrum method. Gaussian noise with 0.01 standard variation is added to all measurements. The error is defined in Eq. 15.

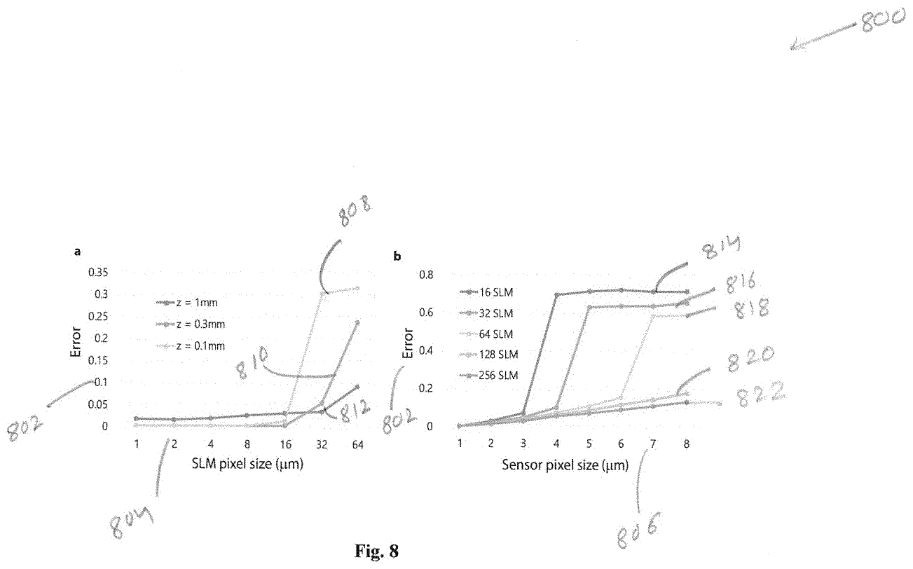

First, to show how SLM pixel size affects the reconstruction, δₛₑₙₛₒᵣ is fixed at 1 μm and the number of SLM patterns is fixed to be 16, vary δ_{SLM} as well as the propagation distance z to see the reconstruction error. As shown in FIG. 8a, when SLM pixel size is small (i.e., M is small), the algorithm can recover the unknown field correctly. Then, the error jumps a lot after a critical SLM pixel size, which is decided by the condition whether the sensor pixel collects the field from one or multiple SLM pixels. This critical size increases as the propagation distance z increases. But large propagation distance z brings another practical issue because part of light propagates outside of the sensor.

Second, to show how sensor pixel size affects the reconstruction, δ_{SLM} is fixed at 1 μm and z is fixed at 500 μm, vary δₛₑₙₛₒᵣ and number of SLM patterns to see the reconstruction error. Given fixed sensor size, larger pixel size means fewer measurements, leading to large reconstruction error. To increase the number of measurements, more SLM patterns are necessary for accurate reconstruction. Results are shown in FIG. 8b when the sensor area is fixed to be 512 μm×512 μm.

In one or more embodiments, simulation and reconstruction, sampling requirements have to be satisfied for accurate calculation. One special case is to represent the large-aperture Fresnel lens.

The phase of the Fresnel lens can be regarded as perfect quadratic phase with large aberrations. Similar to quadratic phase, the spatial frequency increases linearly as the radius increases, which means a large-size needs an extremely high sample rate. For example, supposing the Fresnel lens in our experiment (D=3 inch, f=10 inch) has perfect quadratic phase, a 40,000×40,000 complex matrix is needed to represent it without aliasing artifacts. It requires over 25 G memory to store such a matrix in MATLAB, and more extra memory to operate the matrix (e.g., perform an FFT). Also, our wavefront sensor only has about 10-megapixel resolution. It is impossible to measure a Fresnel lens which has 1.6 billion unknowns.

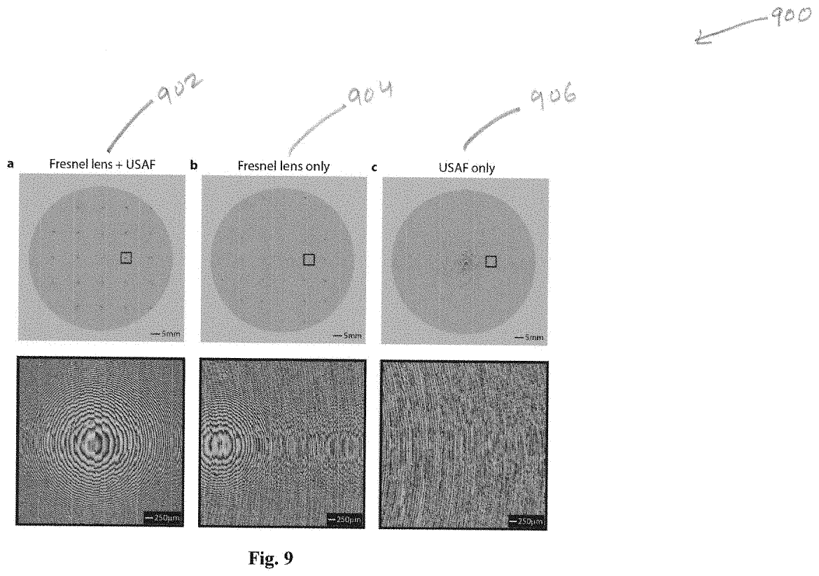

Therefore, to recover the field of the unknown object falling on the Fresnel lens plane, one key insight here is that, for long-distance imaging where the distance between the object and the lens is much larger than the focal length of the lens, the object field contains much smaller spatial frequency than the Fresnel lens does on the Fresnel lens plane. Based on the Eq. 4, the modulation of the Fresnel lens F is removed from the entire field P_{-z}_{₂}u₃ to find out the object field on the Fresnel lens plane. Even through aliasing artifacts are present in F and P_{-z}_{₂}u₃, they are canceled out by each other, and the remaining low-frequency object field is not aliased, as long as the sampling rate is sufficient to represent the object field. The experimental results to image a USAF resolution target with the Fresnel lens are demonstrated in FIG. 9. In particular, FIG. 9 shows that in the long-distance imaging experiment, the sampling constraint for the Fresnel lens can be relaxed as long as the target object is not aliased. FIG. 9(a) shows the recovered phase containing both the Fresnel lens and the USAF target. The zoom-in region shows the aliasing effect. Section (a) corresponds to the phase of P_{-z}_{₂}u₃ which is from the Fresnel lens with the USAF target. FIG. 9b shows the calibrated phase of the Fresnel lens. It is also aliased as shown in the zoom-in figure. Section (b) is the phase of the Fresnel lens F. Both two sections contain aliasing artifacts. But the phase of the USAF target itself (FIG. 9c) is still correct. FIG. 9c shows the phase of the USAF itself is the difference of FIG. 9(a) and FIG. 9(b). By canceling out the high-frequency part, the left USAF phase is not aliased. Thus, method in the present disclosure is not limited by the required sampling rate of the lens and save memory 36 times to ensure a standard PC machine can handle the reconstruction task.

Model for Scattering Media

In one or more embodiments, in the section of imaging through scattering media, rather than regarding the diffuser as a transmission matrix, which blindly maps inputs to outputs, diffuser is physically modeled as a thin plane with random aberrations. In this way, the number of unknowns are dramatically reduced from O(N²) to O(N), where N is the resolution of the input field (i.e., N=10⁷). As a result, the number of input fields for calibration reduces from 10⁷ to 1, making it feasible for the experiment. This thin diffuser assumption is valid for scattering media such as thin tissue and diffuse wall, indicating exciting applications in imaging beneath the skin and looking around the corner. For more complicated scattering material, diffuser may be modeled as a series of 2D scattering slices between which light propagates, which has been proved useful for 3D reconstructions. Combining multi-slices light-propagation model with the WISH is an interesting direction for future work.

Field of View Evaluation

In one or more embodiments, when the incident light rays hit the WISH at a large angle, the Fresnel propagation (FP) and the phase shift of the SLM are not accurate. In the experiment, the largest FOV is about ±6°. Currently, the SLM is the main limit. As for the propagation model, as stated in the method section, although the angular-spectrum propagation (ASP) is more accurate in theory, both FP and ASP gave nearly the same result in our current setup. It means that for our current setup the Fresnel approximation is still satisfied. Specifically, how the error from large incident angle effects three applications is evaluated below.

Long-distance, diffraction-limited imaging with a Fresnel lens: In this case, the largest

F-number used is 0.1 (as the FOV is about ±6°). However, since main objective is long-distance imaging, the resolution is decided by the size of the Fresnel lens instead of the F-number. By scaling up both the focal length and the size of the Fresnel lens equally, the spatial resolution of the target may improve.

Imaging through scattering media: Although the diffuser diffracts light in all directions, the size of the SLM limits the FOV. Thus, the portion of light measured by the WISH has a small incident angle. Because of the random nature of the diffuser, signals from the object in all frequencies are collected and get a reasonably good estimation.

Lensless microscopy: Ideally, the sample may be brought closer to the SLM for higher resolution. In such a microscopic setting if the sample size is much smaller than the SLM, the angle of the light from the sample to a particular pixel on the SLM is fixed. The phase shift of the SLM for this angle is recalibrated before putting into the algorithm. Combining with ASP, a high-resolution reconstruction may be obtained. However, in the current setup, due to the beam splitter, the incident angle is small.

Reconstruction of 3D Objects

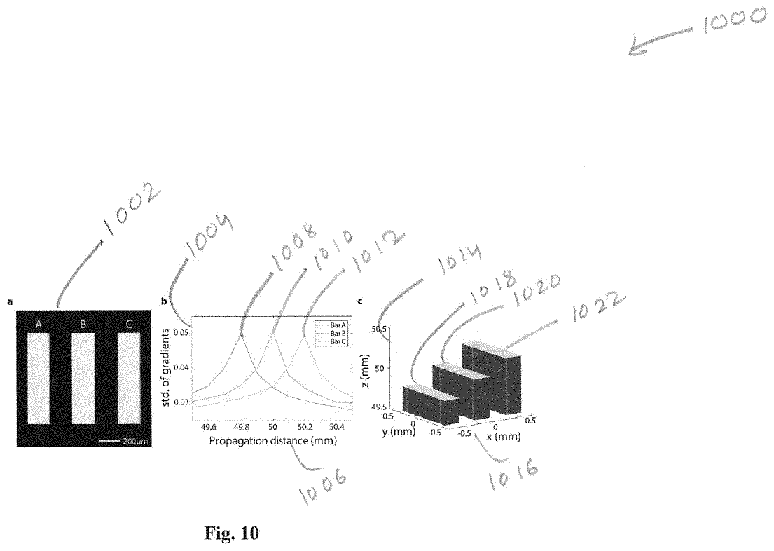

Although current results focus on 2D targets, the method of one or more embodiment may be able to achieve 3D reconstruction. There are two ways to achieve it. First, depth is estimated based on the recovered amplitude. The field to multiple depths are back propagated and find out the correct depth based on the gradient of the recovered amplitude (details are discussed below). As an example, three 2D bars (named as A, B, C) are located at 49.8 mm, 50 mm, and 50.2 mm. The size of each bar is 840 μm×210 μm. FIG. 10a shows the amplitude of the field at 50 mm. Only bar B is in-focus, while bar A and C is out-of-focus. Although the difference is not obvious visually, it may be quantitively evaluated based on the following metric, which is the variance of gradients. For common sharp images, the intensity is always smooth except for boundaries, which means there is a big variation between small gradients (in smooth regions) and large gradients (near the boundaries).

For out-of-focus images, the blurring effect brings the variation closer (i.e., smoothing the boundary and introducing fringes in the smooth region), which reduces the variance of gradients. As shown in FIG. 10b, the standard deviation of the gradients is plotted at regions around each bar with different propagation distance. There are peaks at 49.8 mm, 50 mm, and 50.2 mm for bar A, B, and C, respectively. Next, the in-focus object is recovered by back-propagating the field to the correct depth. FIG. 10c shows a 3D visualization of the result. This method is easy to implement for planar objects at various depths. However, for objects with continuous depth variation, the region for calculating the metric needs to be chosen wisely.

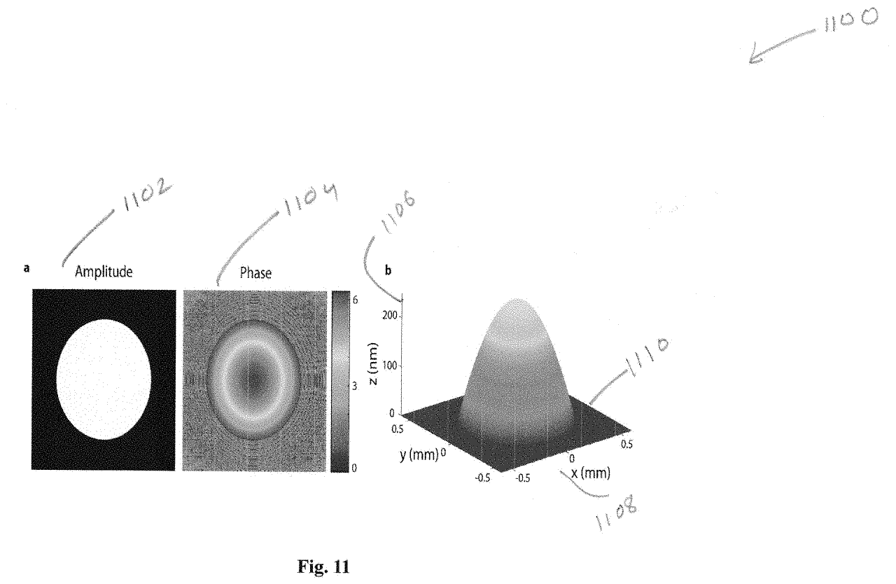

Second, depth is estimated based on the recovered phase. To do so, current setup of some embodiments are changed from transmissive mode to reflective mode, meaning that the incident light bounces back from the object instead of passing through it. Under the circumstances, the depth map is estimated by the phase distribution. FIG. 11 gives one simulation example. It is a disk with quadratic phase distribution (FIG. 11a), in which the amplitude is a disk function and the phase is a quadratic function. FIG. 11b shows the estimated depth map of the object, in which based on the phase distribution, the 3D map of the object is calculated. Due to phase wrapping, the depth range is limited to half of the wavelength. Phase unwrapping is one way to extend the depth range.

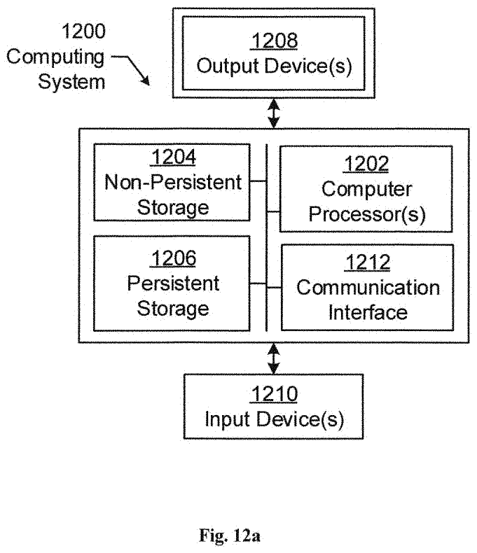

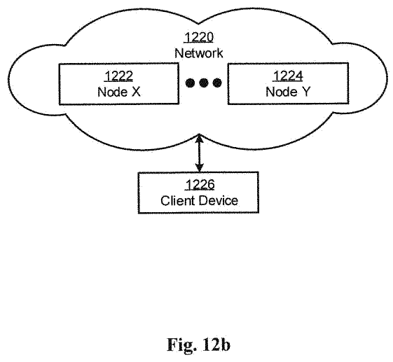

Embodiments may be implemented on a computing system. Any combination of mobile, desktop, server, router, switch, embedded device, or other types of hardware may be used. For example, as shown in FIG. 12a, the computing system (1200) may include one or more computer processors (1202), non-persistent storage (1204) (e.g., volatile memory, such as random access memory (RAM), cache memory), persistent storage (1206) (e.g., a hard disk, an optical drive such as a compact disk (CD) drive or digital versatile disk (DVD) drive, a flash memory, etc.), a communication interface (1212) (e.g., Bluetooth interface, infrared interface, network interface, optical interface, etc.), and numerous other elements and functionalities.

The computer processor(s) (1202) may be an integrated circuit for processing instructions. For example, the computer processor(s) may be one or more cores or micro-cores of a processor. The computing system (1200) may also include one or more input devices (1210), such as a touchscreen, keyboard, mouse, microphone, touchpad, electronic pen, or any other type of input device.

The communication interface (1212) may include an integrated circuit for connecting the computing system (1200) to a network (not shown) (e.g., a local area network (LAN), a wide area network (WAN) such as the Internet, mobile network, or any other type of network) and/or to another device, such as another computing device.

Further, the computing system (1200) may include one or more output devices (1208), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (1202), non-persistent storage (1204), and persistent storage (1206). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (1200) in FIG. 12a may be connected to or be a part of a network. For example, as shown in FIG. 12b, the network (1220) may include multiple nodes (e.g., node X (1222), node Y (1224)). Each node may correspond to a computing system, such as the computing system shown in FIG. 12a, or a group of nodes combined may correspond to the computing system shown in FIG. 12a. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (1200) may be located at a remote location and connected to the other elements over a network.

Although not shown in FIG. 12b, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (1222), node Y (1224)) in the network (1220) may be configured to provide services for a client device (1226). For example, the nodes may be part of a cloud computing system. The nodes may include functionality to receive requests from the client device (1226) and transmit responses to the client device (1226). The client device (1226) may be a computing system, such as the computing system shown in FIG. 12a. Further, the client device (1226) may include and/or perform all or a portion of one or more embodiments of the disclosure.

The computing system or group of computing systems described in FIGS. 12a and 12b may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system (1200) in FIG. 12a. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 12a, while performing one or more embodiments of the disclosure, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 12a may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS.

Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 12a may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 12a and the nodes and/or client device in FIG. 12b. Other functions may be performed using one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A system for a wavefront imaging sensor with high resolution (WISH), comprising:
a spatial light modulator (SLM);
a plurality of image sensors; and
a processor,
wherein the SLM and a computational post-processing algorithm recover an incident wavefront with a high spatial resolution and a fine phase estimation, and
wherein the image sensors work both in a visible electromagnetic (EM) spectrum and outside the visible EM spectrum.

2. The system in claim 1, wherein one or more images are acquired with different patterns on the SLM and the computational post-processing of the acquired one or more images estimate a high resolution wavefront.

3. The system of claim 2, wherein the computational post-processing is done using a computational phase-retrieval algorithm comprising: the processor, configured to estimate a complex optical field including both an amplitude and a phase incident on the SLM and/or the image sensor.

4. The system of claim 2, wherein the computational post-processing algorithm is either based on optimization of an energy functional or based on a neural network trained on data.

5. The system of claim 1, wherein the high spatial resolution of the WISH is determined by a pixel size of the SLM, a pixel size of the image sensor and a distance between the pixel sizes of the SLM and the image sensor, respectively.

6. The system of claim 1, wherein the high spatial resolution of the recovered field in the WISH is in the order of 10-megapixels.

7. The system of claim 1, wherein the WISH captures at least two intensity images sequentially to recover at least one complex optical field.

8. The system of claim 1, wherein the WISH covers different ranges of the EM spectrum such as visible, infrared, thermal, ultra-violet, X-ray, or like ranges.

9. A method for a WISH imaging, comprising:
illuminating a target with a coherent light source;
modulating an incident wavefront from the target by projecting multiple random phase patterns on a SLM;
capturing corresponding a plurality of intensity images using a plurality of image sensors;
acquiring sequential pairs of the phase patterns on the SLM and captured plurality of intensity images;
processing an acquired data using a computational post-processing algorithm; and
recovering a high-resolution wavefront based on the computational post-processing algorithm.

10. The method of claim 9, wherein the computational post-processing is done using a computational phase-retrieval algorithm for estimating a complex optical field including both an amplitude and a phase incident on the SLM and/or the image sensor.

11. The method of claim 9, further comprising capturing at least two intensity images sequentially to recover at least one complex optical field.

12. A non-transitory computer readable medium storing instructions, the instructions executable by a processor and comprising functionality for:
illuminating a target with a coherent light source;
modulating an incident wavefront from the target by projecting multiple random phase patterns on a SLM;
capturing corresponding a plurality of intensity images using a CMOS sensor;
acquiring sequential pairs of the phase patterns on the SLM and captured plurality of intensity images;
processing an acquired data using a computational phase-retrieval algorithm; and
recovering a high-resolution wavefront based on the computational post-processing algorithm.

13. The non-transitory computer readable medium of claim 12, the instructions further comprising functionality for estimating a complex optical field including both an amplitude and a phase incident on the SLM and/or the image sensor.

14. The non-transitory computer readable medium of claim 12, wherein the computational post-processing is done using a computational phase-retrieval algorithm for estimating a complex optical field including both an amplitude and a phase incident on the SLM and/or the image sensor.

15. The non-transitory computer readable medium of claim 12, the instructions further comprising capturing at least two intensity images sequentially to recover at least one complex optical field.
